(19) United States
(12) Patent Application Publication
(10) Pub. No.: US 2008/0094350 A1
(43) Pub. Date: Apr. 24, 2008

(54) ACTIVE MOUSE BUTTON

(75) Inventor: Clifford A. Pickover, Yorktown Heights, NY (US)

Correspondence Address: LENOVO (US) IP Law, 1009 Think Place, Building One, 4th Floor 4B6, Morrisville, NC, 27560, US

(73) Assignee: LENOVO (SINGAPORE) PTE. LTD, Singapore (SG)

(21) Appl. No.: 11/551,874

(22) Filed: Oct. 23, 2006

(51) Int. Cl. G09G 5/00

(52) U.S. Cl. 345/156

(57) ABSTRACT

A computer system, such as a small footprint Person Computer (PC) or notebook computer, PC pointing device and method of displaying information on the PC. The notebook computer includes a pointing device, such as a mouse button, with an illuminated region. The notebook computer also includes a message handler monitoring information streams for changes and a local store storing a response profile of registered illumination responses for corresponding changes in monitored information streams. For each identified change the message handler identifies a corresponding registered response in the response profile and varies illumination from illumination devices (e.g., LEDs) in the illuminated region.

### BACKGROUND OF THE INVENTION

1. Field of the Invention

The present invention is related to computer Input/Output (I/O) devices and more particularly to Personal Computers (PCs) such as notebook PCs with a mouse button type I/O device.

2. Background Description

Small footprint Personal Computers (PCs), such as notebook computers, have a footprint that is defined typically by screen size and the keyboard must fit within the constraints defined by the usually small screen size. Notebook computers, such as the Lenovo ThinkPad®, frequently maintain footprint constraints by including a keyboard mouse button, such as the TrackPoint® from Lenovo, normally found in the middle of the keyboard between the G, H, and B keys. The advantage of the mouse button is that it requires very little space and requires minimal hand movement above the computer keyboard. The typical mouse button functions as a very short joystick or pointing stick and resembles a small knob, nipple, or pencil eraser, and so, is often nicknamed “the pencil eraser” or “the little red button.” Pushing the mouse button in one direction, to the left for example, drives the computer screen cursor in a corresponding direction. Since its original introduction in the early 1990s, many mouse button variants have appeared both on keyboards and on the computer mouse.

While the mouse button allows fitting the manual input peripherals to within the typical compact notebook screen size, because of its small size, the screen may become cluttered very quickly with active applications. Also, other notebook constraints, e.g., available memory, may limit the amount of information that may be displayed or presented on the screen. Since a traveler is likely to be using the notebook in public places, an application presenting important/sensitive information in unexpected pop ups may be making sensitive information inadvertently available to passers by, as well as be interrupting the notebook user's work and otherwise be consuming valuable notebook resources.

Thus, there is a need for selectively notifying a small footprint PC users and especially notebook PC users of events of interest without cluttering the display screen or exposing potentially sensitive information to inadvertent disclosure.

### SUMMARY OF THE INVENTION

It is a purpose of the invention to separately indicate disparate ambient computer conditions without expanding the computer footprint;

It is another purpose of the invention to separately indicate disparate reminders on a computer without expanding the computer footprint;

It is yet another purpose of the invention to separately indicate disparate computer system security information without expanding the computer footprint;

It is yet another purpose of the invention to separately indicate disparate computer system information on a computer without expanding the computer footprint;

It is yet another purpose of the invention to separately indicate disparate computer system information including ambient computer conditions, reminders and system security information on a computer without expanding the computer footprint;

It is yet another purpose of the invention to indicate computer system information including ambient computer conditions, reminders and system security information through illumination on a mouse button or similar computer pointing device.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A-B show an example of a computing system according to a preferred embodiment of the present invention.

FIG. 2 shows a flow chart example of the steps of preferred message handler for controlling the illumination of the pointing device.

FIG. 3 shows an example of a preferred policy table and a record in the policy table for each monitored information/event.

The present invention is related to a computer system, such as a small footprint Person Computer (PC) or notebook computer and method of displaying information on the PC. The notebook computer includes a pointing device, such as a mouse button, with an illuminated region. The notebook computer also includes a message handler monitoring ambient information for changes and a local store storing a response profile of registered illumination responses for corresponding changes in monitored ambient information. For each identified ambient information change the message handler identifies a corresponding registered response in the response profile and varies illumination from illumination devices (e.g., LEDs) in the illuminated region.

A preferred embodiment PC ensures that selected ambient conditions, reminders, system security information, and system properties are conveyed to the user of computer through illumination of the mouse button or similar pointing device on a computer keyboard or computer mouse. The mouse button illumination characteristics are controlled by an “illumination message” sent to a mouse button message handler. Applications may register with the Active Track Point System so that they may send a message that is controlled by policy table. A policy table controls color mapping and color priority when multiple message arrive. The policy table is set by individual, company, IT shop, or computer vendor. Illumination messages may only be permitted from certain application vendors or only certain individuals listed in a policy table.

### DESCRIPTION OF PREFERRED EMBODIMENTS

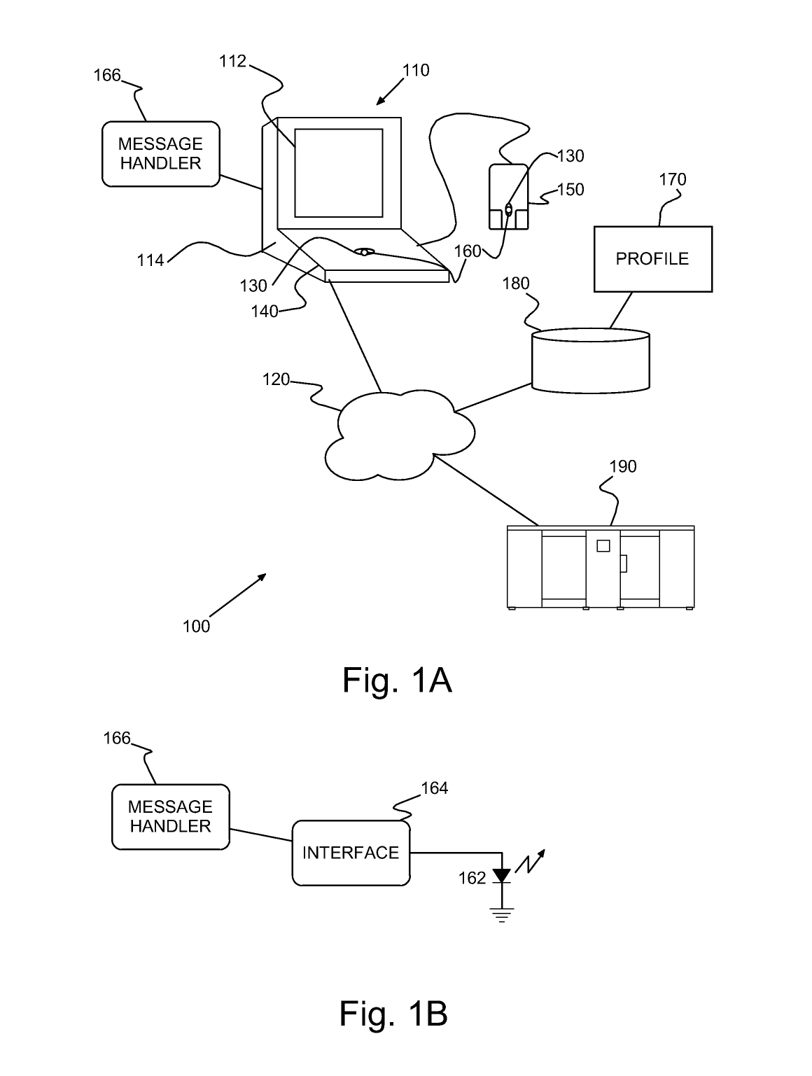

Turning now to the drawings, and more particularly, FIGS. 1A-B show an example of a computing system 100 according to a preferred embodiment of the present invention. Preferably, the computing system 100 is embodied in a small footprint personal computer (PC) 110 operating a typical state of the art operating system such as Windows®, Linux, or AIX. In particular, it is preferred that the small footprint sis a notebook computer, e.g., the Lenovo ThinkPad®, with a typical display 112, e.g., a Liquid Crystal Diode (LCD) display, and processor or CPU 114 that is connectable to a network 120, such as the Internet, either through a wired connection or with a typical wireless network connection, e.g., WiFi, IEEE 802.11g network adapter or a cellular connection. The computer system 100, referred to hereinbelow as a PC, includes at least one preferred Active Track System (ATS), e.g., pointing device 130. The pointing device 130 may be a mouse button, for example, that may be located on the PC keyboard 140 or the PC mouse 150. As used hereinbelow, “pointing device” refers to a mouse button or any similar suitable computer pointing device. The preferred pointing device 130 includes an illuminated region 160 that may change color according to various selected criteria. Illuminators 162 for region 160 may include any suitable illumination device, such as for example, currently available 1.6-mm-wide three-color Light Emitting Diodes (LEDs). A simple electrical interface 164 in the PC 110 under program control by a message handler 166 operating on the PC 110, interfaces with other active PC applications and provides electrical communication with the illuminators 162. Such LED control is well known in the art. The message handler 166, which is described in more detail hereinbelow, operates with the electrical interface 164 to provide communication through illuminator 162 illumination, e.g., varying illumination of the small color LEDs. Preferably, a response profile or policy table 170, e.g., as a data file on local storage 180 in the PC 110 with other applications and data, contains information for controlling the LEDs according to various indications of ambient conditions, reminders, system security information, and system properties. Optionally, the policy table 170 may reside in storage on a remote computer 190, e.g., a server, and made available to the PC 110 over the network 120. For this optional embodiment, the remote computer 190 may be maintained by the user, a company, a service bureau, or third party.

Thus, a preferred pointing device 130 provides a typical state of the art PC with a visual indicator that notifies and allows a user to visualize various aspects of the world through controlled illumination at the illuminators 162. The visual indications indicate selected ambient conditions, reminders, system security information, and system properties. The visual indication characteristics may include color, blink rate and brightness and are selected/controlled by an “illumination message” from the mouse button message handler 166. Active PC applications may register with the PC 110, e.g., with the message handler 166 to respond with a visual indicator passed through the electrical interface 164 as indicated in the policy table 170. So, for example, an individual, company policy, an Information Technology (IT) shop, or a computer vendor may set/select visual indication characteristics. Preferably, the policy table 170 controls color mapping and color priority when multiple message arrive. Initiating illumination messages may be restricted to responses from certain application vendors or only certain individuals listed in the policy table 170.

So for example, when a PC user wishes to monitor various external events, without further inconvenience of looking at a crowded computer screen; the preferred pointing device 130 allows the user to display and receive such disparate information, e.g., in a mouse button or other similar pointing device that is located on a keyboard or mouse, through controlled illumination and set by user policies. Since the preferred pointing device 130 is front and foremost in the PC, it also illuminates the mouse button, e.g., in dark environments, and provides uniform messages on any equipped desktop or laptop computer. Furthermore, the illumination may be provided even if the mouse button is disabled, the screen saver is on or, the display is dimmed or off.

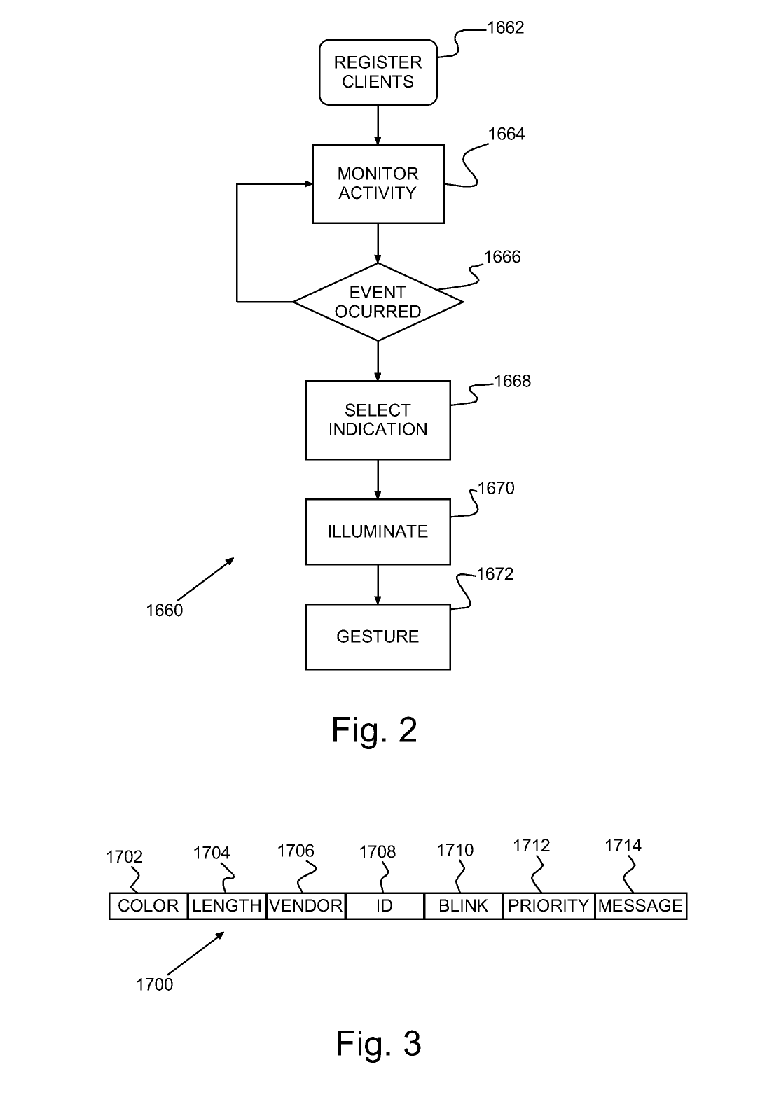

FIG. 2 shows a flow chart example 1660 of the steps of controlling the illumination of the pointing device according to a preferred embodiment of the present invention, e.g., by preferred message handler 166 in FIGS. 1A-B. Beginning in step 1662, applications may register with the preferred message handler 166 providing specific events in information to be monitored and for indication at the illuminators 162. Information may be monitored for example, for specific ambient conditions, reminders and system information, e.g., security and property information. Registered events are entered in the policy table 170 and stored, locally 180 or remotely on remote computer 190. Next, in step 1664 the message handler 166 begins monitoring system activity and ambient information for registered events. In step 1666 when the message handler 166 receives an indication that such an event has occurred; then, in step 1668 the message handler 166 determines the appropriate illumination, e.g., color, brightness, and/or blink rate. In step 1670 the message handler 166 directs the electrical interface 164 to modify illuminators 162 to provide the selected illumination. So, for example, a red LED or a blue LED may be activated for solid blue or red illumination or pulsed for blinking red or blue. Both may be activated or pulsed for purple. Optionally, in step 1672 the user may respond through the pointing device 130, providing an appropriate gesture to acknowledge and/or initiate a pre-selected response.

So, the preferred message handler 166 receives information streams in step 1666 and checks for registered events such as ambient conditions, reminders and system information, e.g., security and property information. Monitored ambient conditions may include, for example, rise and fall of the stock market, health of user's stock portfolio, predicted and current weather changes, and traffic congestion. Monitored reminders may include, for example, calendar reminders; indicators if user's boss, spouse, or child is logged on to instant messenger; and whether or not an important mail or instant message pending. Monitored system security information may include, for example, the presence of viruses or adware, the severity of uninstalled software updates, potentially harmful incoming traffic, the presence of browser parasites, spyware, malicious browser helper objects, or spam. Monitored system property information may include, for example, used disk space, number of unread e-mails, quality of network connectivity, time since last software patch update.

So, a remote service may communicate with the PC 110 over network 120, providing weather information and/or stock market information. Such remote services that provide digital information (e.g., a message from an information provider or stream data) to registered clients are well known in the art. Also, a typical such message or information stream may originate from a software application, the user's system, a remote system, or another user, for example. The information, e.g. stock information, may be in the form of a digital message forwarded to the message handler 166. Although the messages may have any form, an example of a message event, is “Lenovo +5” from a remote application and received by the message handler 166.

In step 1668 the message handler 166 converts received messages or identified events, e.g., to color. So, local or remote applications, such as stock market monitors, may register with the message handler 166 to send an appropriate message indicated in the policy table 170. For example, the illuminated region 160 may be green if a stock market index is increasing or red if it is decreasing. The message handler 166 controls mapping information to illumination characteristics guided by the policy table in policy table 170. The particular illumination color, blink rate and brightness are arbitrarily selected and may be selected as a default when conditions are normal or no message is incoming. So for example, when there are no pending instant messages or discovered viruses, the illuminated region 160 may default to blue. Also, the illumination may be enabled even when the mouse button is disabled, e.g., to use a touchpad or external mouse. Thus, with default illumination the illuminated region 160 illuminates the mouse button device in shadows or dark environments and even if screen saver is on or the display is dim or off.

In step 1670, the electrical interface 164 selectively activates the appropriate illumination devices with the selected characteristics to illuminate the illuminated region 160. The electrical interface 164 may respond, for example, with a corresponding LED that blinks whenever the PC 110 receives a computer cookie, executable, or other item. Thus, the blinking LED alerts the PC user to possible concerns or problems. The blinking may continue while the condition exist, is being remedied or until the user acknowledges it. As noted hereinabove, selectable illumination characteristics may include, for example, color, intensity, and/or blink rate. Optionally, illumination messages may be displayed in parallel, i.e., simultaneously. For example, the illuminated region 160 may blink red and then green to indicate that a virus is on the system and that a computer administrator wants to discuss this problem with the system user.

A response to the illumination may be provided in optional step 1672, by gesturing with the pointing device 130. If, for example, the illuminated region is red to indicate that stock values have fallen below a threshold, moving the pointing device 130 with a counter clockwise motion, or side to side motion, may indicate information related to the illumination message, e.g., sell the stock. Also, selected gestures can be designated to trigger specific PC responses, e.g., install or run software, or pop up an e-mail window.

FIG. 3 shows an example of a preferred policy table 170, which contains a record 1700 for each monitored information event with reference to the example of FIGS. 1A-B. Upon receiving monitored information in step 1666 the message handler 166 determines from the preferred policy table 170 the appropriate illumination response for the illuminated region 130, e.g., bright green, blinking at 20 Hz. So, each record 1700 may include information such as, for example, an illumination color field 1702, an illumination duration field 1704, a vendor field 1706, an ID field 1708, a blink rate field 1710, a priority field 1712 and optionally, a message field 1714. The color field 1702 indicates the color of the illuminated region 130, e.g., red or green. The duration field 1704 indicates the length of time for the particular illumination, e.g., 5 seconds of green when the stockmarket rises. The vendor field 1706 indicates a particular vendor associated with the record 1700, e.g., Lenovo™, IBM® or Microsoft®. Optionally, vendors that are not listed in the policy table may be prevented from controlling the color (field 1702) for the illuminatd region. Vendors listed in the table may have permission to change the illumination characteristics. The ID field 1708 may also be checked for permission to send a message to the illuminated region. The ID field 1708 may include e-mail addresses of, for example, incoming messages to the PC 110 that vary illumination of the pointing device. So, for example, e-mail from a first remote user listed in the policy table 170 may light up the pointing device red, whereas e-mail from a second remote unlisted user may be ignored.

Entries in the blink field 1710 control the blink rate. So, for example, a zero 0 may indicate no blink where, 0.2 indicates a 0.2 second period or 5 Hz. Entries in the priority field 1712 control the priority for which illumination message alters the illuminated region 130, e.g., when several messages are received simultaneously. So, a virus warning with priority 1 may change the illuminated region red, and a lower priority message, e.g., a buddy e-mail, may be blocked by the virus warning. Also, entries in the priority field 1712 may indicate that a message may be more important or crucial than another, e.g., system problems are more important than the weather; some stocks may be more important than others. Priorities in the priority field 1712 may be set, for example, by a user, group of users, government, a company, service bureau, financial analyst, or third party. Further, the priorities may be dynamically varied, e.g., on the weekend the priorities may be set to monitor social information, such as whether a friend is logged on, over a stock market indicator. Again the dynamic of nature of these priorities may be set manually, for example, by a user, group of users, or company, or determined automatically by the system.

Entries in the message field 1714 map to the illumination event, e.g., indicating a color change. For example, “73” in the message field 1714 may indicate a stock market increase, while “644” in message field 1714 may indicate that a virus has been found. Various software applications may use these codes (i.e. Messages) as needed.

Advantageously, using a preferred PC, users visually receive various indications of real time events identified in dynamic information streams. The indications may be varied and the information may be selected to include financial events, weather events, and system information events. Because of the central position of the mouse button or related pointing device, the illuminated region is readily visible and indications are prominently displayed. By providing a convenient indication, coupled to an optional gesture response, users are more likely to be notified about important information and be informed of pending maintenance tasks, e.g., information associated with system security issues, and to perform such maintenance tasks in a timely manner. Further, users may respond with a specific gesture on the illuminated pointing device, causing the PC to provide the user more detailed information or instructions.

Moreover, although described herein with reference to inclusion in a pointing device such as a mouse button, this is for example only and not intended as a limitation. Almost any suitable I/O device, including wirelessly connected I/O devices, may include an illuminated region, such as for example, a keyboard, a keyboard key, a wrist rest, a cell phone, the display bezel, the mouse, the notebook computer case, a clothing belt, a watch, earrings, a car steering wheel, eyeglass frames, a watch, or a necklace. Suitable wireless connection may include infra-red (IR) connections, Bluetooth, and wi-fi, for example. Also, some state of the art cell phones, e.g., the Nokia 6620, have a mouse button-like device that may include an illuminated region. In another example, the entire computer mouse may glow or eyeglass frames may be equipped to turn red or green based on the stock market with illumination also visible on frame interior.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. A computer system comprising:
a processor under program control and selectively monitoring information streams;
a local store selectively storing programs for execution by said processor and data for said programs;
a display displaying information responsive to said processor;
a keyboard receiving manual user input, received said manual user input being provided to said processor; and
an illuminated region on said computer system external to said display, variation of illumination in said illuminated region indicating corresponding changes in said monitored information streams.

2. A computer system as in claim 1, wherein said computer system is a small footprint Personal Computer (PC) further comprising:
a pointing device providing positional information to said processor, positional information being selectively displayed on said display, said illuminated region being located on said pointing device.

3. A small footprint PC as in claim 2, wherein said pointing device is a mouse button.

4. A small footprint PC as in claim 3, wherein said mouse button is located on a mouse connected to and communicating with said processor.

5. A small footprint PC as in claim 3, wherein said mouse button is located on said keyboard.

6. A small footprint PC as in claim 3, further comprising:
a response profile indicating illumination responses to selected said corresponding changes;
a message handler receiving indications of said selected corresponding changes and identifying a corresponding illumination response in said response profile; and
an illumination device interface selectively driving illumination devices responsive to identified illumination responses.

7. A small footprint PC as in claim 6, wherein said illumination devices are Light Emitting Diodes (LEDs) and said illumination device interface selects an LED for color, alters brightness, and controls blink rate responsive to said identified illumination responses.

8. A small footprint PC as in claim 6, wherein said small footprint PC is connected over a network to a remote computer, said response profile being stored in storage on said remote computer.

9. A small footprint PC as in claim 6, further comprising local storage storing said response profile.

10. A small footprint PC as in claim 6, wherein said small footprint PC is a notebook computer.

11. A notebook computer as in claim 10, connected to a network and monitoring selected ambient information streams, changes in monitored said information streams including selected system parameter information and said monitored said selected ambient information streams.

12. A method of providing a visual indication of changes in selected information streams, said method comprising the steps of:
a) registering selected events with a computer system;
b) monitoring computer system activity and selected ambient information streams for a registered event;
c) providing an illumination indication responsive to the occurrence of an identified registered event; and
d) illuminating an illuminated region on said computer system according to said illumination indication and responsive to said occurrence.

13. A method as in claim 12, wherein events registerable in step (a) comprise one or more of:
selected ambient condition changes;
reminders;
system security events;
system parameters changes; and
real time status indications.

14. A method as in claim 13, wherein selected ambient condition changes comprise one or more of:
stock market variations;
stock portfolio health;
predicted weather changes; and
traffic congestion.

15. A method as in claim 13, wherein reminders comprise one or more of:
calendar reminders;
active instant messenger buddies;
indicated pending mail identified as important; and
pending instant messages.

16. A method as in claim 13, wherein system security events comprise one or more of:
an indication of the presence of a system virus;
an indication of the presence of adware;
an indication of pending updates for installation;
an indication of potentially harmful incoming traffic;
an indication of the presence of browser parasites;
an indication of the presence of spyware;
an indication of the presence of malicious browser helper objects; and
an indication of the presence of spam.

17. A method as in claim 13, wherein system parameter changes comprise one or more of:
used disk space changes;
unread email present changes;
connectivity quality changes; and
elapsed time since a last software patch update.

18. A method as in claim 13, wherein real time status indications comprise one or more of:
normal system activity;
incoming cookies and executables; and
system response to another monitored activity.

19. A method as in claim 12, wherein the step (a) of registering comprises entering a record in a policy table, said record indicating a selected illumination response for a corresponding event.

20. A method as in claim 19, wherein the step (c) of providing the illumination indication comprises:
i) indicating the occurrence of a registered event to a message handler;
ii) retrieving a response to said registered event from a policy table; and
iii) providing the retrieved said response to an illumination interface.

21. A method as in claim 20, wherein said message handler retrieves a response selected from the group comprising color, intensity and blink rate.

22. A method as in claim 2 1, wherein entered said records include an illumination color field, an illumination duration field, a vendor field, an ID field, a blink rate field, and a priority field.

23. A method as in claim 22, said method further comprising the step of:
e) receiving a gesture from an input device connected to said computer, said computer responding to said event responsive to said gesture with a response indicated in a message field in one of said records.

24. A method as in claim 22, wherein said records control color mapping and color priority when multiple message arrive.

25. A small footprint Personal Computer (PC) comprising:
a pointing device receiving positional information, positional information being selectively displayed on a PC display;
an illuminated region on said pointing device;
a response profile of registered illumination responses for corresponding changes in identified information streams;
a message handler monitoring said identified information streams for registered changes and for each identified registered change, identifying a corresponding response in said response profile; and
at least one illumination device in said illuminated region being selectively varied according to an identified said corresponding response.

26. A small footprint PC as in claim 25, wherein said small footprint PC is a notebook computer and said pointing device is a mouse button on a mouse connected to said notebook computer.

27. A small footprint PC as in claim 25, wherein said small footprint PC is a notebook computer and said pointing device is a mouse button on a keyboard.

28. A notebook computer as in claim 26, wherein said at least one illumination device is a plurality of Light Emitting Diodes (LEDs) and registered illumination responses include LED, brightness, and blink rate.

29. A notebook computer as in claim 28, wherein said notebook computer is connected over a network to a remote computer, said response profile being stored in storage on said remote computer.

30. A notebook computer as in claim 28, connected to a network and monitoring selected external information streams, said identified information streams including selected system parameters and said changes in monitored said selected external information streams.
